(19) United States
(12) Patent Application Publication
(10) Pub. No.: US 2016/0177089 A1
(43) Pub. Date: Jun. 23, 2016

(54) REFLECTIVE POLYCARBONATE COMPOSITION

(71) Applicants: Liang WEN, Pudong, Shanghai (CN); Wibowo HARSONO, Pudong, Shanghai (CN); Mingfeng LI, Pudong, Shanghai (CN)

(72) Inventors: Liang WEN, Shanghai (CN); Wibowo HARSONO, Shanghai (CN); Mingfeng LI, Shanghai (CN)

(21) Appl. No.: 14/910,100

(22) PCT Filed: Aug. 6, 2013
(86) PCT No.: PCT/CN2013/080919

§ 371 Date: Feb. 4, 2016

(51) Int. Cl. C08L 69/00; C08K 13/02; C08K 5/42; C08K 5/5399; C08K 9/10; C08K 5/45

(52) U.S. Cl. CPC C08L 69/00; C08K 9/10; C08K 5/45; C08K 5/42; C08K 5/5399; C08K 13/02; C08L 2201/02; C08L 2205/025

(57) ABSTRACT

A reflector suitable for use with light sources is disclosed. The reflector is made from a polycarbonate composition comprising a polycarbonate polymer, a white colorant, a fluorescent brightener, and a flame retardant. The reflector has good reflectivity and mechanical strength at very low thicknesses.

### BACKGROUND

The present disclosure relates to polycarbonate compositions that can be used to make highly reflective articles, (i.e. an article with a highly reflective surface). The resulting articles have a combination of thin wall flame retardance (FR) and high reflectivity at low thicknesses. These compositions can be useful for various applications, for example lighting.

Polycarbonates (PC) are synthetic engineering thermoplastic resins, and are a useful class of polymers having many beneficial properties. With their strength and clarity, polycarbonate resins offer many significant advantages and are used for a number of different commercial applications, including electronic engineering (E&E) parts, mechanical parts and so on.

Because of their broad use, it is desirable to provide polycarbonates having good flame retardance. The market is also moving towards articles having thin walls for purposes of slimness, weight reduction, and size reduction of the overall final product. With decreasing wall thickness, it becomes increasingly difficult to render the article flame retardant.

Sources, such as compact fluorescent lamps (CFL) or light emitting diodes (LED), are becoming increasingly popular with consumers. Reflectors can be used in lighting components to mix and diffuse light emitted from a light source and reflect that light back towards the desired environment. Reflectors are widely used in both LED lamps and television backlights to improve luminance. Foamed polyethylene terephthalate (PET) is widely used as a reflector due to its high reflectivity. However, foamed PET is expensive and soft, making it difficult to handle and leading to rougher surfaces than desired. It would be desirable to provide other materials that can used to make a reflector.

### BRIEF DESCRIPTION

The present disclosure relates to polycarbonate compositions which can be used to form highly reflective articles that have good mechanical strength and thin wall FR performance. The compositions include a polycarbonate polymer, a white colorant, a fluorescent brightener, and a flame retardant.

Disclosed in various embodiments is a reflective polycarbonate composition, comprising: from about 10 wt % to about 90 wt % of a polycarbonate polymer; from about 5 wt % to about 60 wt % of a white colorant; from about 0.01 wt % to about 0.1 wt % of a fluorescent brightener; and from about 0.05 wt % to about 20 wt % of a flame retardant; wherein the polycarbonate composition has a reflectivity (R %) of 96% or greater at 1.0 mm thickness and has V0 performance at 1.0 mm thickness.

The white colorant may be titanium dioxide, zinc sulfide, zinc oxide, or barium sulfate. In specific embodiments, the white colorant is coated titanium dioxide. The polycarbonate composition may contain from about 5 wt % to about 30 wt % of the white colorant.

The fluorescent brightener may contain two benzoxazolyl groups. In specific embodiments, the fluorescent brightener is 4,4′-bis(2-benzoxazolyl) stilbene or 2,5-bis(5-tert-butyl-2-benzoxazolyl) thiophene.

The flame retardant can be a perfluorobutane sulfonic acid salt, or can be a phosphazene flame retardant. The phosphazene flame retardant may have the structure of Formula (II) or Formula (III), as defined further herein.

The polycarbonate composition may further comprise from about 5 wt % to about 50 wt % of a polycarbonate-polysiloxane copolymer.

In specific embodiments, the polycarbonate composition has a reflectivity (R %) of 96% or greater at 0.3 mm thickness and has V0 performance at 0.8 mm thickness.

The polycarbonate polymer may have a weight average molecular weight of from about 15,000 to about 30,000.

In various embodiments, the composition has an MFR of 6 g/10 min or higher when measured at 300° C., 1.2 kg according to ASTM D1238.

In other embodiments, the composition has a pFTP(V0) of at least 0.90 and a flame out time (FOT) of about 40 seconds or less at 0.8 mm thickness.

The polycarbonate composition can further comprise from about 0.05 wt % to about 1 wt % of an anti-drip agent.

Sometimes, the polycarbonate polymer comprises a high molecular weight polycarbonate polymer having a Mw above 25,000 and a low molecular weight polycarbonate polymer having a Mw below 25,000. The weight ratio of the high molecular weight polycarbonate polymer to the low molecular weight polycarbonate polymer can be from about 20:80 to about 80:20.

In some specific embodiments, the polycarbonate composition comprises: from about 70 wt % to about 80 wt % of the high molecular weight polycarbonate polymer; from about 3 wt % to about 10 wt % of the low molecular weight polycarbonate polymer; from about 15 wt % to about 25 wt % of the white colorant; from about 0.01 wt % to about 0.1 wt % of the fluorescent brightener; from about 0.3 wt % to about 0.6 wt % of the flame retardant; from about 0.05 to about 0.3 wt % of an anti-drip agent; from about 0.3 wt % to about 0.5 wt % of a mold release agent; and from about 0.01 to about 0.1 wt % of a phosphite stabilizer.

Also disclosed in various embodiments is a reflective polycarbonate composition, comprising: from about 10 wt % to about 90 wt % of a polycarbonate polymer; from about 5 wt % to about 60 wt % of a white colorant; and from about 0.01 wt % to about 0.1 wt % of a fluorescent brightener; wherein the polycarbonate composition has a reflectivity (R %) of 96% or greater at 1.0 mm thickness and has V2 performance at 0.3 mm thickness.

In more specific embodiments, the polycarbonate composition comprises: from about 65 wt % to about 75 wt % of the polycarbonate polymer; from about 15 wt % to about 35 wt % of the white colorant; from about 0.01 wt % to about 0.1 wt % of the fluorescent brightener; from about 0.1 wt % to about 0.5 wt % of a mold release agent; and from about 0.01 to about 0.1 wt % of a phosphite stabilizer.

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a graph showing reflectivity versus thickness for a composition of the present disclosure.

FIG. 2 is a graph showing the reflectivity after UV aging of compositions of the present disclosure, showing that the addition of a fluorescent brightener does not affect UV resistance.

FIG. 3 is a picture of a film of the present disclosure formed at a temperature of 178° C.

FIG. 4 is a picture of a film of the present disclosure formed at a temperature of 197° C.

FIG. 5 is a picture of a foamed PET film formed at 160° C. for comparison.

FIG. 6 is a picture of a foamed PET film formed at 174° C. for comparison.

FIG. 7 is a picture of a foamed PET film formed at 187° C. for comparison.

FIG. 8 is a picture of a 0.25 mm thick film formed from a polycarbonate composition of the present disclosure.

FIG. 9 is a picture of a 0.25 mm thick film formed from foamed PET for comparison to FIG. 8.

### DETAILED DESCRIPTION

The present disclosure may be understood more readily by reference to the following detailed description of desired embodiments and the examples included therein. In the following specification and the claims which follow, reference will be made to a number of terms which shall be defined to have the following meanings.

The singular forms “a,” “an,” and “the” include plural referents unless the context clearly dictates otherwise.

As used in the specification and in the claims, the term “comprising” may include the embodiments “consisting of” and “consisting essentially of.”

Numerical values in the specification and claims of this application, particularly as they relate to polymers or polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

As used herein, approximating language may be applied to modify any quantitative representation that may vary without resulting in a change in the basic function to which it is related. Accordingly, a value modified by a term or terms, such as “about” and “substantially,” may not be limited to the precise value specified. The modifier “about” should also be considered as disclosing the range defined by the absolute values of the two endpoints. For example, the expression “from about 2 to about 4” also discloses the range “from 2 to 4.”

It should be noted that weight percentage or “wt %”, is based on the total weight of the polymeric composition.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, the aldehyde group —CHO is attached through the carbon of the carbonyl group.

The term “aliphatic” refers to a linear or branched array of atoms that is not cyclic and has a valence of at least one. Aliphatic groups are defined to comprise at least one carbon atom. The array of atoms may include heteroatoms such as nitrogen, sulfur, silicon, selenium and oxygen in the backbone or may be composed exclusively of carbon and hydrogen. Aliphatic groups may be substituted or unsubstituted. Exemplary aliphatic groups include, but are not limited to, methyl, ethyl, isopropyl, isobutyl, hydroxymethyl (—CH₂OH), mercaptomethyl (—CH₂SH), methoxy, methoxycarbonyl (CH₃OCO—), nitromethyl (—CH₂NO₂), and thiocarbonyl.

The term “alkyl” refers to a linear or branched array of atoms that is composed exclusively of carbon and hydrogen. The array of atoms may include single bonds, double bonds, or triple bonds (typically referred to as alkane, alkene, or alkyne). Alkyl groups may be substituted (i.e. one or more hydrogen atoms is replaced) or unsubstituted. Exemplary alkyl groups include, but are not limited to, methyl, ethyl, and isopropyl. It should be noted that alkyl is a subset of aliphatic.

The term “aromatic” refers to an array of atoms having a valence of at least one and comprising at least one aromatic group. The array of atoms may include heteroatoms such as nitrogen, sulfur, selenium, silicon and oxygen, or may be composed exclusively of carbon and hydrogen. Aromatic groups are not substituted. Exemplary aromatic groups include, but are not limited to, phenyl, pyridyl, furanyl, thienyl, naphthyl and biphenyl.

The term “aryl” refers to an aromatic radical composed entirely of carbon atoms and hydrogen atoms. When aryl is described in connection with a numerical range of carbon atoms, it should not be construed as including substituted aromatic radicals. For example, the phrase “aryl containing from 6 to 10 carbon atoms” should be construed as referring to a phenyl group (6 carbon atoms) or a naphthyl group (10 carbon atoms) only, and should not be construed as including a methylphenyl group (7 carbon atoms). It should be noted that aryl is a subset of aromatic.

The term “cycloaliphatic” refers to an array of atoms which is cyclic but which is not aromatic. The cycloaliphatic group may include heteroatoms such as nitrogen, sulfur, selenium, silicon and oxygen in the ring, or may be composed exclusively of carbon and hydrogen. A cycloaliphatic group may comprise one or more noncyclic components. For example, a cyclohexylmethyl group (C₆H₁₁CH₂—) is a cycloaliphatic functionality, which comprises a cyclohexyl ring (the array of atoms which is cyclic but which is not aromatic) and a methylene group (the noncyclic component). Cycloaliphatic groups may be substituted or unsubstituted. Exemplary cycloaliphatic groups include, but are not limited to, cyclopropyl, cyclobutyl, 1,1,4,4-tetramethylcyclobutyl, piperidinyl, and 2,2,6,6-tetramethylpiperydinyl.

The term “cycloalkyl” refers to an array of atoms which is cyclic but is not aromatic, and which is composed exclusively of carbon and hydrogen. Cycloalkyl groups may be substituted or unsubstituted. It should be noted that cycloalkyl is a subset of cycloaliphatic.

In the definitions above, the term “substituted” refers to at least one hydrogen atom on the named radical being substituted with another functional group, such as alkyl, halogen, —OH, —CN, —NO₂, —COOH, etc.

The term “perfluoroalkyl” refers to a linear or branched array of atoms that is composed exclusively of carbon and fluorine.

The term “room temperature” refers to a temperature of 23° C.

One method of measuring colors is the CIELAB color space. This color space uses three dimensions, L*, a*, and b*. L* is the lightness or L-value, and can be used as a measure of the amount of light transmission through the polycarbonate resin. The values for L* range from 0 (black) to 100 (diffuse white). The dimension a* is a measure of the color between magenta (positive values) and green (negative values). The dimension b* is a measure of the color between yellow (positive values) and blue (negative values), and may also be referred to as measuring the blueness of the color or as the b-value. Colors may be measured under DREOLL conditions.

The polycarbonate compositions of the present disclosure include (A) at least one polycarbonate polymer; (B) a white colorant; (C) a fluorescent brightener; and (D) a flame retardant. Articles made from the compositions have a combination of desirable properties, specifically good thin-wall flame retardance (FR) and high reflectivity at low thicknesses.

As used herein, the terms “polycarbonate” and “polycarbonate polymer” mean compositions having repeating structural carbonate units of the formula (1):

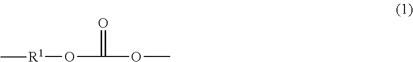

in which at least about 60 percent of the total number of R¹ groups are aromatic organic radicals and the balance thereof are aliphatic, alicyclic, or aromatic radicals. An ester unit (—COO—) is not considered a carbonate unit, and a carbonate unit is not considered an ester unit. In one embodiment, each R¹ is an aromatic organic radical, for example a radical of the formula (2):

-A¹-Y¹-A²- (2)

wherein each of A^{l} and A² is a monocyclic divalent aryl radical and Y¹ is a bridging radical having one or two atoms that separate A^{l} from A². In an exemplary embodiment, one atom separates A^{l} from A². Illustrative non-limiting examples of radicals of this type are —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ may be a hydrocarbon group or a saturated hydrocarbon group such as methylene, cyclohexylidene, or isopropylidene.

Polycarbonates may be produced by the interfacial reaction of dihydroxy compounds having the formula HO—R¹—OH, wherein R¹ is as defined above. Dihydroxy compounds suitable in an interfacial reaction include the dihydroxy compounds of formula (A) as well as dihydroxy compounds of formula (3)

HO-A¹-Y¹-A²-OH (3)

wherein Y¹, A^{l} and A² are as described above. Also included are bisphenol compounds of general formula (4):

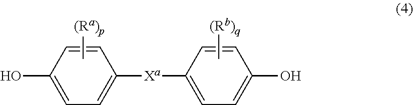

wherein R^{a} and R^{b} each represent a halogen atom or a monovalent hydrocarbon group and may be the same or different; p and q are each independently integers of 0 to 4; and X^{a} represents one of the groups of formula (5):

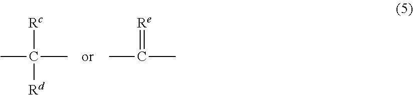

wherein R^{c} and R^{d} each independently represent a hydrogen atom or a monovalent linear or cyclic hydrocarbon group and R^{e} is a divalent hydrocarbon group.

Specific examples of the types of bisphenol compounds that may be represented by formula (3) include 1,1-bis(4-hydroxyphenyl) methane, 1,1-bis(4-hydroxyphenyl) ethane, 2,2-bis(4-hydroxyphenyl) propane (hereinafter “bisphenol-A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, and 1,1-bis(4-hydroxy-t-butylphenyl) propane. Combinations comprising at least one of the foregoing dihydroxy compounds may also be used.

Branched polycarbonates are also useful, as well as blends of a linear polycarbonate and a branched polycarbonate. The branched polycarbonates may be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane (THPE), isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents may be added at a level of about 0.05 wt % to about 2.0 wt %.

“Polycarbonates” and “polycarbonate polymers” as used herein further includes blends of polycarbonates with other copolymers comprising carbonate chain units. An exemplary copolymer is a polyester carbonate, also known as a copolyester-polycarbonate. Such copolymers further contain, in addition to recurring carbonate chain units of the formula (1), repeating units of formula (6):

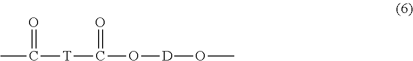

wherein D is a divalent radical derived from a dihydroxy compound, and may be, for example, a C₂₋₁₀ alkylene radical, a C₆₋₂₀ alicyclic radical, a C₆₋₂₀ aromatic radical or a polyoxyalkylene radical in which the alkylene groups contain 2 to about 6 carbon atoms, specifically 2, 3, or 4 carbon atoms; and T is a divalent radical derived from a dicarboxylic acid, and may be, for example, a C₂₋₁₀ alkylene radical, a C₆₋₂₀ alicyclic radical, a C₆₋₂₀ alkyl aromatic radical, or a C₆₋₂₀ aromatic radical.

In one embodiment, D is a C₂₋₆ alkylene radical. In another embodiment, D is derived from an aromatic dihydroxy compound of formula (7):

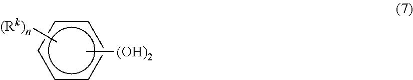

wherein each R^{k} is independently a C₁₋₁₀ hydrocarbon group, and n is 0 to 4. The halogen is usually bromine. Examples of compounds that may be represented by the formula (7) include resorcinol, substituted resorcinol compounds such as 5-methyl resorcinol, 5-phenyl resorcinol, 5-cumyl resorcinol, or the like; catechol; hydroquinone; substituted hydroquinones such as 2-methyl hydroquinone, 2-t-butyl hydroquinone, 2-phenyl hydroquinone, 2-cumyl hydroquinone, 2,3,5,6-tetramethyl hydroquinone, or the like; or combinations comprising at least one of the foregoing compounds.

Examples of aromatic dicarboxylic acids that may be used to prepare the polyesters include isophthalic or terephthalic acid, 1,2-di(p-carboxyphenyl)ethane, 4,4′-dicarboxydiphenyl ether, 4,4′-bisbenzoic acid, and mixtures comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or mixtures thereof.

In other embodiments, poly(alkylene terephthalates) may be used. Specific examples of suitable poly(alkylene terephthalates) are poly(ethylene terephthalate) (PET), poly(1,4-butylene terephthalate) (PBT), poly(ethylene naphthanoate) (PEN), poly(butylene naphthanoate), (PBN), (polypropylene terephthalate) (PPT), polycyclohexanedimethanol terephthalate (PCT), and combinations comprising at least one of the foregoing polyesters.

Copolymers comprising alkylene terephthalate repeating ester units with other ester groups may also be useful. Useful ester units may include different alkylene terephthalate units, which can be present in the polymer chain as individual units, or as blocks of poly(alkylene terephthalates). Specific examples of such copolymers include poly(cyclohexanedimethylene terephthalate)-co-poly(ethylene terephthalate), abbreviated as PETG where the polymer comprises greater than or equal to 50 mol % of poly(ethylene terephthalate), and abbreviated as PCTG where the polymer comprises greater than 50 mol % of poly(1,4-cyclohexanedimethylene terephthalate).

Poly(cycloalkylene diester)s may also include poly(alkylene cyclohexanedicarboxylate)s. Of these, a specific example is poly(1,4-cyclohexanedimethanol-1,4-cyclohexanedicarboxylate) (PCCD), having recurring units of formula (8):

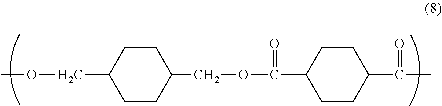

wherein, as described using formula (6), R² is a 1,4-cyclohexanedimethylene group derived from 1,4-cyclohexanedimethanol, and T is a cyclohexane ring derived from cyclohexanedicarboxylate or a chemical equivalent thereof, and may comprise the cis-isomer, the trans-isomer, or a combination comprising at least one of the foregoing isomers.

Another exemplary copolymer comprises polycarbonate blocks and polydiorganosiloxane blocks, also known as a polycarbonate-polysiloxane copolymer. The polycarbonate blocks in the copolymer comprise repeating structural units of formula (1) as described above, for example wherein R¹ is of formula (2) as described above. These units may be derived from reaction of dihydroxy compounds of formula (3) as described above.

The polydiorganosiloxane blocks comprise repeating structural units of formula (9) (sometimes referred to herein as ‘siloxane’):

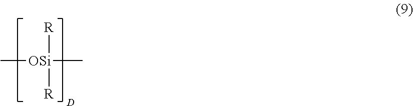

wherein each occurrence of R is same or different, and is a C₁₋₁₃ monovalent organic radical. For example, R may be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₀ aryl group, C₆-C₁₀ aryloxy group, C₇-C₁₃ aralkyl group, C₇-C₁₃ aralkoxy group, C₇-C₁₃ alkaryl group, or C₇-C₁₃ alkaryloxy group. Combinations of the foregoing R groups may be used in the same copolymer. Generally, D may have an average value of 2 to about 1000, specifically about 2 to about 500, more specifically about 10 to about 75. Where D is of a lower value, e.g., less than about 40, it may be desirable to use a relatively larger amount of the polycarbonate-polysiloxane copolymer. Conversely, where D is of a higher value, e.g., greater than about 40, it may be necessary to use a relatively lower amount of the polycarbonate-polysiloxane copolymer.

In one embodiment, the polydiorganosiloxane blocks are provided by repeating structural units of formula (10):

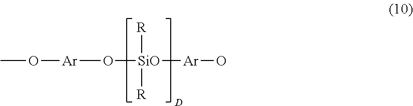

wherein D is as defined above; each R may be the same or different, and is as defined above; and Ar may be the same or different, and is a substituted or unsubstituted C₆-C₃₀ arylene radical, wherein the bonds are directly connected to an aromatic moiety. Suitable Ar groups in formula (10) may be derived from a C₆-C₃₀ dihydroxyarylene compound, for example a dihydroxyarylene compound of formula (3), (4), or (7) above. Combinations comprising at least one of the foregoing dihydroxyarylene compounds may also be used.

Such units may be derived from the corresponding dihydroxy compound of the following formula (11):

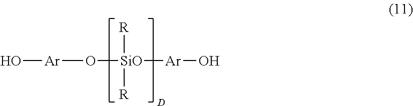

wherein Ar and D are as described above. Compounds of this formula may be obtained by the reaction of a dihydroxyarylene compound with, for example, an alpha, omega-bisacetoxypolydiorangonosiloxane under phase transfer conditions.

In another embodiment the polydiorganosiloxane blocks comprise repeating structural units of formula (12):

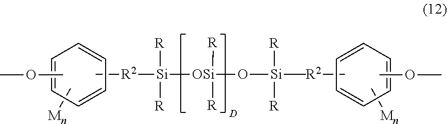

wherein R and D are as defined above. R² in formula (12) is a divalent C₂-C₈ aliphatic group. Each M in formula (12) may be the same or different, and may be cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₈-C₁₀ aryl, C₈-C₁₀ aryloxy, C₇-C₁₂ aralkyl, C₇-C₁₂ aralkoxy, C₇-C₁₂ alkaryl, or C₇-C₁₂ alkaryloxy, wherein each n is independently 0, 1, 2, 3, or 4.

In one embodiment, M is an alkyl group such as methyl, ethyl, or propyl, an alkoxy group such as methoxy, ethoxy, or propoxy, or an aryl group such as phenyl, or tolyl; R² is a dimethylene, trimethylene or tetramethylene group; and R is a C₁₋₈ alkyl, haloalkyl such as trifluoropropyl, cyanoalkyl, or aryl such as phenyl or tolyl. In another embodiment, R is methyl, or a mixture of methyl and phenyl. In still another embodiment, M is methoxy, n is one, R² is a divalent C₁-C₃ aliphatic group, and R is methyl.

These units may be derived from the corresponding dihydroxy polydiorganosiloxane (13):

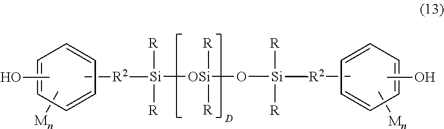

wherein R, D, M, R², and n are as described above.

Such dihydroxy polysiloxanes can be made by effecting a platinum catalyzed addition between a siloxane hydride of the formula (14),

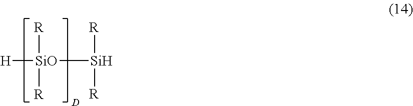

wherein R and D are as previously defined, and an aliphatically unsaturated monohydric phenol. Suitable aliphatically unsaturated monohydric phenols included, for example, eugenol, 2-alkylphenol, 4-allyl-2-methylphenol, 4-allyl-2-phenylphenol, 4-allyl-2-t-butoxyphenol, 4-phenyl-2-phenylphenol, 2-methyl-4-propylphenol, 2-allyl-4,6-dimethylphenol, 2-allyl-6-methoxy-4-methylphenol and 2-allyl-4,6-dimethylphenol. Mixtures comprising at least one of the foregoing may also be used.

Suitable polycarbonates can be manufactured by processes known in the art, such as interfacial polymerization and melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a suitable catalyst such as triethylamine or a phase transfer catalyst, under controlled pH conditions, e.g., about 8 to about 10. Generally, in the melt polymerization process, polycarbonates may be prepared by co-reacting, in a molten state, the dihydroxy reactant(s) and a diaryl carbonate ester, such as diphenyl carbonate, in the presence of a transesterification catalyst in a Banbury® mixer, twin screw extruder, or the like to form a uniform dispersion. Volatile monohydric phenol is removed from the molten reactants by distillation and the polymer is isolated as a molten residue.

In specific embodiments, the polycarbonate polymer (A) is derived from a dihydroxy compound having the structure of Formula (I):

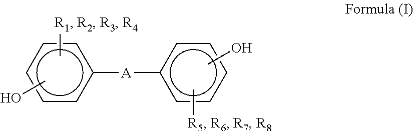

wherein R₁ through R₈ are each independently selected from hydrogen, nitro, cyano, C₁-C₂₀ alkyl, C₄-C₂₀ cycloalkyl, and C₆-C₂₀ aryl; and A is selected from a bond, —O—, —S—, —SO₂—, C₁-C₁₂ alkyl, C₆-C₂₀ aromatic, and C₆-C₂₀ cycloaliphatic.

In specific embodiments, the dihydroxy compound of Formula (I) is 2,2-bis(4-hydroxyphenyl) propane (i.e. bisphenol-A or BPA). Other illustrative compounds of Formula (I) include: 2,2-bis(4-hydroxy-3-isopropylphenyl)propane; 2,2-bis(3-t-butyl-4-hydroxyphenyl)propane; 2,2-bis(3-phenyl-4-hydroxyphenyl)propane; 1,1-bis(4-hydroxyphenyl)cyclohexane; 4,4′dihydroxy-1,1-biphenyl; 4,4′-dihydroxy-3,3′-dimethyl-1,1-biphenyl; 4,4′-dihydroxy-3,3 ‘-dioctyl-1,1-biphenyl; 4,4’-dihydroxydiphenylether; 4,4′-dihydroxydiphenylthioether; and 1,3-bis(2-(4-hydroxyphenyl)-2-propyl)benzene.

In more specific embodiments, the polycarbonate polymer (A) is a bisphenol-A homopolymer. The polycarbonate polymer may have a weight average molecular weight (Mw) of from about 15,000 to about 70,000 daltons, according to polycarbonate standards, including a range of from about 15,000 to about 30,000 daltons. The polycarbonate polymer can be a linear or branched polycarbonate, and in more specific embodiments is a linear polycarbonate.

In some embodiments of the present disclosure, the polycarbonate composition includes two polycarbonate polymers, i.e. a first polycarbonate polymer (A1) and a second polycarbonate polymer (A2). The two polycarbonate polymers may have the same or different monomers.

The first polycarbonate polymer has a greater weight average molecular weight than the first polycarbonate polymer. The first polycarbonate polymer may have a weight average molecular weight of above 25,000 (measured by GPC based on BPA polycarbonate standards), including above 30,000. The second polycarbonate polymer may have a weight average molecular weight of below 25,000 (measured by GPC based on BPA polycarbonate standards). In embodiments, the weight ratio of the first polycarbonate polymer to the second polycarbonate polymer is usually from about 20:80 to about 80:20. Note the weight ratio described here is the ratio of the amounts of the two copolymers in the composition, not the ratio of the molecular weights of the two copolymers.

The weight ratio between the two polycarbonate polymers can affect the flow properties, ductility, and surface aesthetics of the final composition. The blends may include from about 10 to about 90 wt % of the first polycarbonate polymer and the second polycarbonate polymer, including from about 55 wt % to about 80 wt %. The blend may contain from about 20 to about 80 wt % of the first polycarbonate polymer (higher MW). The blend may contain from about 5 to about 85 wt % of the second polycarbonate polymer (lower MW). When blended together, the two polycarbonate polymers can have an average molecular weight of from about 20,000 to about 30,000.

Suitable polycarbonates can be manufactured by processes known in the art, such as interfacial polymerization and melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a suitable catalyst such as triethylamine or a phase transfer catalyst, under controlled pH conditions, e.g., about 8 to about 10. Generally, in the melt polymerization process, polycarbonates may be prepared by co-reacting, in a molten state, the dihydroxy reactant(s) and a diaryl carbonate ester, such as diphenyl carbonate, in the presence of a transesterification catalyst in a Banbury® mixer, twin screw extruder, or the like to form a uniform dispersion. Volatile monohydric phenol is removed from the molten reactants by distillation and the polymer is isolated as a molten residue.

The polycarbonate compositions of the present disclosure also include a white colorant (B). For example, the white colorant may be titanium dioxide, zinc sulfide, zinc oxide, or barium sulfate. The white colorant may be present in the blends of the present disclosure in amounts of from about 5 wt % to about 60 wt % of the composition, including from about 5 wt % to about 30 wt %, or from about 20 wt % to about 40 wt %, or from about 15 wt % to about 35 wt %.

Generally, the white colorant has a high refractive index, wherein a high refractive index is greater than 1.7. Desirably, the refractive index is greater than or equal to 2. Possible white colorants having this high refractive index include titanium dioxide (such as rutile and anatase), zinc oxide, zinc sulfide, antimony oxide, and combinations comprising at least one of the foregoing. The white colorant can be treated with inorganic treatments such as one or more of hydrated alumina, silicon dioxide, sodium silicates, sodium aluminates, sodium aluminum silicates, zinc oxide, zirconium oxide, and mica. These treatments can act as building blocks in the construction of the white colorant and can be selectively precipitated such that they occur close to the surface in the individual particles. These treatments can be used as dispersing aids and/or neutralizing agents.

The white colorant can be uncoated or coated, wherein the coating can be layered with one or more coating layers. Suitable coating agents can include one or more of silane coupling agents including alkyl alkoxysilane and polyorganohydrogen siloxane; silicone oil; alkyl hydrogen polysiloxanes; polyorganosiloxanes; alcohols including trimethylolpropanol; polyols including trimethylol propane; alkyl phosphates; phosphorylated fatty acids; higher fatty acid ester; acid compounds such as phosphorus acid, phosphoric acid, carboxylic acid, and carboxylic anhydride; wax; and other coating agents. Specialized coatings such as titanate coupling agents including isopropyl triisostearoyl titanate can be incorporated. The white colorant can have a metal coating such that the colorant either bonds with the polycarbonate or has little to no interaction with the polycarbonate. Possible metals include aluminum, titanium, boron, and so forth. Some examples of coatings include silicon dioxide; a metal oxide (such as aluminum oxide); and a metal nitride (such as boron nitride, silicon nitride, and titanium nitride); as well as combinations comprising at least one of the foregoing. Generally, the white colorant and the coating have different compositions. For example, the white colorant can be a coated titanium dioxide. Possible coatings include inorganic (e.g. alumina) and/or organic coatings (e.g. polysiloxane), where the inorganic coating can comprise 0 to 5 wt % silica or alumina and the organic coating can comprise 0 to 3 wt % of an hydrophobic organic surfactant. Hence, the white colorant can be alumina coated titanium dioxide, alumina and polysiloxane coated titanium dioxide, and/or polysiloxane coated titanium dioxide. For example, the white colorant is a titanium dioxide having an R2 classification pursuant to DIN EN ISO 591, Part 1, that is stabilized with compound(s) of aluminum and/or silicon, and has a titanium dioxide purity of greater than or equal to 96.0%. An example of a titanium dioxide is Kronos 2233, commercially available from Kronos Worldwide, Inc.

The white colorant, e.g., titanium dioxide, can be coated or uncoated, and can have an average particle size of less than 500 nm, specifically, 30 nm to 500 nm, specifically, 50 nm and 500 nm, more specifically, 170 nm to 350 nm, yet more specifically, 100 nm to 250 nm, and even 150 nm to 200 nm. For example, the white colorant, e.g., titanium dioxide, can have an average particle size of greater than or equal to 30 nm, specifically, less than or equal to 180 nm, e.g., 30 nm to 180 nm. The average particle size can be greater than or equal to 170 nm as smaller particle sizes can appear to be more blue, which may result in a lower reflectivity.

In particular embodiments, the white colorant is a titanium dioxide having an R2 classification pursuant to DIN EN ISO 591, Part 1, that is stabilized with compound(s) of aluminum and/or silicon, has a titanium dioxide purity of greater than or equal to 96.0%. An example of a suitable titanium dioxide is Kronos 2233, commercially available from Kronos Worldwide, Inc.

The polycarbonate compositions also include a fluorescent brightener (C). The brightener improves the reflectivity of the final article. Fluorescence is the emission of light by the colorant after absorbing light or other electromagnetic radiation, and is a form of luminescence. Usually, the light emitted by the fluorescent brightener has a longer wavelength (i.e. lower energy) than the absorbed radiation. The fluorescent brightener may be present in the blends of the present disclosure in amounts of from about 0.01 wt % to about 0.1 wt % of the composition.

In specific embodiments, the fluorescent brightener contains two benzoxazolyl groups. Specific examples of such fluorescent brighteners include 4,4′-bis(2-benzoxazolyl) stilbene (commercially available as TINOPAL OB R513 from Ciba) and 2,5-bis(5-tert-butyl-2-benzoxazolyl) thiophene (commercially available as OB-1 from Eastman), which are illustrated below:

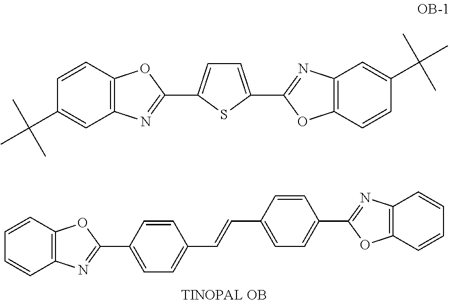 [SMILES: CC(C)(C)c1ccc2oc(-c3ccc(-c4nc5cc(C(C)(C)C)ccc5o4)s3)nc2c1 ; C(=C\c1ccc(-c2nc3ccccc3o2)cc1)/c1ccc(-c2nc3ccccc3o2)cc1]

The polycarbonate compositions also comprise a flame retardant (D). The flame retardant additive (D) is present in the blend in an amount of from about 0.01 wt % to about 20 wt %, including from about 0.3 wt % to about 5 wt %. More than one flame retardant additive may be present, i.e. combinations of such additives are contemplated. Desirably, the flame retardant additive does not contain bromine or chlorine.

In particular embodiments, a salt-based flame retardant is used. The flame retardant may be a K, Na, or Li salt. Useful salt-based flame retardants include alkali metal or alkaline earth metal salts of inorganic protonic acids and organic Bronstëd acids comprising at least one carbon atom. These salts should not contain chlorine and/or bromine. Preferably, the salt-based flame retardants are sulfonic acid salts. For example, the flame retardant additive can be a perfluoroalkane sulfonic acid salt. In specific embodiments, the salt-based flame retardant is selected from the group consisting of potassium diphenylsulfon-3-sulfonate (KSS), potassium perfluorobutane sulfonate (Rimar salt), and combinations comprising at least one of the foregoing.

In other embodiments, the flame retardant is a phosphazene flame retardant. For example, the phosphazene flame retardant may be a cyclic phosphazene of Formula (II) or a linear phosphazene of Formula (III):

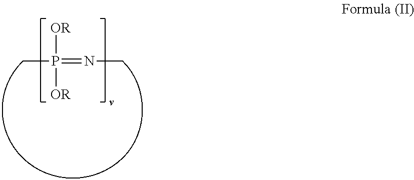

wherein R is alkyl or aryl; and wherein v is an integer from 3 to 25;

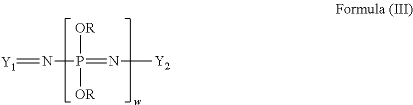

wherein R is alkyl or aryl; w is an integer from 3 to about 1,000; Y₁ is —P(OR)₃ or —P(═O)(OR); and Y₂ is —P(OR)₄ or —P(═O)(OR)₂. In particular embodiments of both Formula (II) and Formula (III), R is phenyl (—C₆H₅). These phosphazenes can also be crosslinked. An exemplary phosphazene flame retardant is SPB-100, a diphenoxyphosphazene commercially available from Otsuka Chemical Co., Ltd., believed to be a phosphazene of Formula (II) where R=phenyl and v=3.

When a phosphazene flame retardant is used, the blend may further comprise a polycarbonate-polysiloxane copolymer. The siloxane blocks may make up from greater than zero to about 25 wt % of the polycarbonate-polysiloxane copolymer, including from 4 wt % to about 25 wt %, from about 4 wt % to about 10 wt %, or from about 15 wt % to about 25 wt %, or from about 6 wt % to about 20 wt %. The polycarbonate blocks may make up from about 75 wt % to less than 100 wt % of the block copolymer, including from about 75 wt % to about 85 wt %. It is specifically contemplated that the polycarbonate-polysiloxane copolymer is a diblock copolymer. The polycarbonate-polysiloxane copolymer may have a weight average molecular weight of from about 28,000 to about 32,000. The polycarbonate-polysiloxane copolymer may be present in the polycarbonate composition in the amount of from about 5 wt % to about 50 wt %, including from about 12 wt % to about 16 wt %. Generally, the amount of the polycarbonate-polysiloxane copolymer is sufficient for the overall polycarbonate blend to contain from about 2 wt % to about 5 wt % of siloxane. For example, if the polycarbonate-polysiloxane copolymer contains 20 wt % of siloxane, the blend may contain from about 14 to about 24 wt % of the polycarbonate-polysiloxane copolymer.

In particular embodiments, the blend also comprises an anti-drip agent (E). Anti-drip agents include, for example a fibril forming or non-fibril forming fluoropolymer such as polytetrafluoroethylene (PTFE). The anti-drip agent may be encapsulated by a rigid copolymer as described above, for example SAN. PTFE encapsulated in SAN is known as TSAN. Encapsulated fluoropolymers may be made by polymerizing the encapsulating polymer in the presence of the fluoropolymer, for example, in an aqueous dispersion. TSAN may provide significant advantages over PTFE, in that TSAN may be more readily dispersed in the composition. A suitable TSAN may comprise, for example, about 50 wt % PTFE and about 50 wt % SAN, based on the total weight of the encapsulated fluoropolymer. The SAN may comprise, for example, about 75 wt % styrene and about 25 wt % acrylonitrile based on the total weight of the copolymer. Alternatively, the fluoropolymer may be pre-blended in some manner with a second polymer, such as for, example, an aromatic polycarbonate resin or SAN to form an agglomerated material for use as an anti-drip agent. Either method may be used to produce an encapsulated fluoropolymer. The anti-drip agent can be present in an amount of from about 0.05 wt % to about 1 wt % of the blend.

In embodiments, the polycarbonate blends of the present disclosure comprise from about 10 wt % to about 90 wt % of the at least one polycarbonate polymer (A); from about 5 wt % to about 60 wt % of the white colorant (B); from about 0.01 wt % to about 0.1 wt % of the fluorescent brightener (C); and from about 0.05 wt % to about 20 wt % of the flame retardant (D).

In more specific embodiments, the polycarbonate blends of the present disclosure comprise from about 55 wt % to about 80 wt % of the at least one polycarbonate polymer (A); from about 20 wt % to about 40 wt % of the white colorant (B); from about 0.01 wt % to about 0.1 wt % of the fluorescent brightener (C); and from about 0.3 wt % to about 5 wt % of the flame retardant (D).

Sometimes the polycarbonate blends of the present disclosure comprise from about 10 wt % to about 90 wt % of the at least one polycarbonate polymer (A); from about 5 wt % to about 60 wt % of the white colorant (B); from about 0.01 wt % to about 0.1 wt % of the fluorescent brightener (C); and from about 1 wt % to about 20 wt % of a phosphazene flame retardant (D); and from about 5 wt % to about 50 wt % of a polycarbonate-polysiloxane copolymer.

In more specific embodiments, the polycarbonate blends of the present disclosure comprise from about 70 wt % to about 80 wt % of the first polycarbonate polymer having a weight average molecular weight of above 25,000 (A1); from about 3 wt % to about 10 wt % of the second polycarbonate polymer having a weight average molecular weight of below 25,000 (A2); from about 15 wt % to about 25 wt % of the white colorant (B); from about 0.01 wt % to about 0.1 wt % of the fluorescent brightener (C); and from about 0.3 wt % to about 0.6 wt % of the flame retardant (D). These embodiments may also further include from about 0.05 to about 0.3 wt % of an anti-drip agent; from about 0.3 wt % to about 0.5 wt % of a mold release agent; and from about 0.01 to about 0.1 wt % of a phosphite stabilizer.

The polycarbonate compositions of the present disclosure have a combination of high reflectivity at low thicknesses and good flame retardance at thin wall thicknesses.

The polycarbonate compositions of the present disclosure have a reflectivity (% R) of 96% or greater at 1.0 mm thickness. The reflectivity is measured according to DREOLL conditions in the CIELAB color space relative to CIE standard illuminant D50. In more specific embodiments, the polycarbonate compositions have a reflectivity (% R) of 96% or greater at 0.3 mm thickness. Generally, the reflectivity increases as the thickness increases. This property can be measured using a ColorEye 7000A available from X-rite. This property can also be called reflectance. In addition, the compositions may have an L-value of 98 or higher.

The polycarbonate blends of the present disclosure may achieve V0 performance at a thickness of 1.0 mm or 0.8 mm, when measured according to UL94. In other embodiments, the polycarbonate blends have a specified pFTP and flame out time (FOT). These are discussed in the Examples herein. In some embodiments, the polycarbonate blends have a pFTP(V0) of at least 0.90 and a flame out time (FOT) of about 40 seconds or less at 0.8 mm thickness.

The polycarbonate blends of the present disclosure may have a melt flow rate (MFR) of 6 g/10 minutes or higher when measured according to ASTM D1238 at 300° C. and a 1.2 kg load. In additional embodiments, the MFR is 10 g/10 minutes or higher. The MFR may reach a maximum of about 25 g/10 minutes. It should be noted that a higher MFR is desirable, and that polycarbonate blends having an MFR greater than 25 g/10 min should also be considered within the scope of this disclosure.

The polycarbonate compositions of the present disclosure may have any combination of these properties (reflectivity, FR performance, MFR), and any combination of the listed values for these properties. It should be noted that some of the properties are measured using articles made from the polycarbonate composition; however, such properties are described as belonging to the polycarbonate composition for ease of reference.

In some specific embodiments, the composition has a reflectivity (% R) of 96% or greater at 1.0 mm thickness and has V0 performance at 1.0 mm thickness.

In some specific embodiments, the composition has a reflectivity (% R) of 96% or greater at 1.0 mm thickness; has V0 performance at 1.0 mm thickness; and has an MFR of 10 g/10 min or higher.

In some specific embodiments, the composition has a reflectivity (% R) of 96% or greater at 1.0 mm thickness; has V0 performance at 1.0 mm thickness; and has a pFTP(V0) of at least 0.90 and a flame out time (FOT) of about 40 seconds or less at 0.8 mm thickness.

In some specific embodiments, the composition has a reflectivity (% R) of 96% or greater at 0.3 mm thickness and has V0 performance at 0.8 mm thickness.

Other additives ordinarily incorporated in polycarbonate blends of this type can also be used, with the proviso that the additives are selected so as to not significantly adversely affect the desired properties of the polycarbonate. Combinations of additives can be used. Such additives can be mixed at a suitable time during the mixing of the components for forming the composition. In embodiments, one or more additives are selected from at least one of the following: UV stabilizing additives, thermal stabilizing additives, mold release agents, and gamma-stabilizing agents.

Exemplary antioxidant additives include, for example, organophosphites such as tris(nonyl phenyl)phosphite, tris(2,4-di-t-butylphenyl)phosphite (e.g., “IRGAFOS 168” or “1-168”), bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. Antioxidants are generally used in amounts of 0.0001 to 1 wt % of the overall polycarbonate composition.

Exemplary heat stabilizer additives include, for example, organophosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, phosphates such as trimethyl phosphate, or the like, or combinations comprising at least one of the foregoing heat stabilizers. Heat stabilizers are generally used in amounts of 0.0001 to 1 wt % of the overall polycarbonate composition.

Light stabilizers and/or ultraviolet light (UV) absorbing additives can also be used. Exemplary light stabilizer additives include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or the like, or combinations comprising at least one of the foregoing light stabilizers. Light stabilizers are generally used in amounts of 0.0001 to 1 wt % of the overall polycarbonate composition.

Exemplary UV absorbing additives include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB® 5411); 2-hydroxy-4-n-octyloxybenzophenone (CYASORB® 531); 2-[4,6-bis(2,4-dimethylphenyl)-1,3,5-triazin-2-yl]-5-(octyloxy)-phenol (CYASORB® 1164); 2,2′-(1,4-phenylene)bis(4H-3,1-benzoxazin-4-one) (CYASORB® UV-3638); 1,3-bis[(2-cyano-3,3-diphenylacryloyl)oxy]-2,2-bis[[(2-cyano-3, 3-diphenylacryloyl)oxy]methyl]propane (UVINUL® 3030); 2,2′-(1,4-phenylene) bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than or equal to 100 nanometers; or the like, or combinations comprising at least one of the foregoing UV absorbers. UV absorbers are generally used in amounts of 0.0001 to 1 wt % of the overall polycarbonate composition.

Plasticizers, lubricants, and/or mold release agents can also be used. There is considerable overlap among these types of materials, which include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate (PETS), and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, e.g., methyl stearate and polyethylene-polypropylene glycol copolymer in a suitable solvent; waxes such as beeswax, montan wax, paraffin wax, or the like. Such materials are generally used in amounts of 0.001 to 1 wt %, specifically 0.01 to 0.75 wt %, more specifically 0.1 to 0.5 wt % of the overall polycarbonate composition.

Radiation stabilizers can also be present, specifically gamma-radiation stabilizers. Exemplary gamma-radiation stabilizers include alkylene polyols such as ethylene glycol, propylene glycol, 1,3-propanediol, 1,2-butanediol, 1,4-butanediol, meso-2,3-butanediol, 1,2-pentanediol, 2,3-pentanediol, 1,4-pentanediol, 1,4-hexandiol, and the like; cycloalkylene polyols such as 1,2-cyclopentanediol, 1,2-cyclohexanediol, and the like; branched alkylenepolyols such as 2,3-dimethyl-2,3-butanediol (pinacol), and the like, as well as alkoxy-substituted cyclic or acyclic alkanes. Unsaturated alkenols are also useful, examples of which include 4-methyl-4-penten-2-ol, 3-methyl-pentene-3-ol, 2-methyl-4-penten-2-ol, 2,4-dimethyl-4-pene-2-ol, and 9 to decen-1-ol, as well as tertiary alcohols that have at least one hydroxy substituted tertiary carbon, for example 2-methyl-2,4-pentanediol (hexylene glycol), 2-phenyl-2-butanol, 3-hydroxy-3-methyl-2-butanone, 2-phenyl-2-butanol, and the like, and cyclic tertiary alcohols such as 1-hydroxy-1-methyl-cyclohexane. Certain hydroxymethyl aromatic compounds that have hydroxy substitution on a saturated carbon attached to an unsaturated carbon in an aromatic ring can also be used. The hydroxy-substituted saturated carbon can be a methylol group (—CH₂OH) or it can be a member of a more complex hydrocarbon group such as —CR⁴HOH or —CR⁴OH wherein R⁴ is a complex or a simple hydrocarbon. Specific hydroxy methyl aromatic compounds include benzhydrol, 1,3-benzenedimethanol, benzyl alcohol, 4-benzyloxy benzyl alcohol and benzyl benzyl alcohol. 2-Methyl-2,4-pentanediol, polyethylene glycol, and polypropylene glycol are often used for gamma-radiation stabilization. Gamma-radiation stabilizing compounds are typically used in amounts of 0.1 to 10 wt % of the overall polycarbonate composition.

The polycarbonate compositions of the present disclosure may be molded into pellets. The compositions may be molded, foamed, or extruded into various structures or articles by known methods, such as injection molding, overmolding, extrusion, rotational molding, blow molding and thermoforming.

In particular, it is contemplated that the polycarbonate compositions of the present disclosure are used to mold thin-wall articles, particularly for lighting applications. Non-limiting examples of such articles include a reflector, a film, a lamp shade, and a light tube. Articles made using the present compositions are stronger, and can be made at thicknesses as low as 0.25 mm and still maintain its shape without bending.

The present disclosure further contemplates additional fabrication operations on said articles, such as, but not limited to, molding, in-mold decoration, baking in a paint oven, lamination, and/or thermoforming. The polycarbonate compositions are especially useful for making articles that have parts with a wall thickness of 1.0 mm or less, or 0.8 mm or less. It is recognized that molded parts can have walls that vary in thickness, and these values refer to the thinnest parts of those walls, or the “thinnest thickness”. Put another way, the article has at least one wall that is 1.0 mm/0.8 mm or less in thickness.

Certain specific embodiments include the following. In an embodiment, a reflective polycarbonate composition comprises: from about 10 wt % to about 90 wt % of a polycarbonate polymer, specifically a polycarbonate polymer having a weight average molecular weight of from about 15,000 to about 30,000, or a combination of a high molecular weight polycarbonate polymer having a Mw above 25,000 and a low molecular weight polycarbonate polymer having a Mw below 25,000, for example wherein the weight ratio of the high molecular weight polycarbonate polymer to the low molecular weight polycarbonate polymer is from about 20:80 to about 80:20; from about 5 wt % to about 60 wt %, specifically to about 30 wt %, of a white colorant, for example titanium dioxide, zinc sulfide, zinc oxide, or barium sulfate, and specifically coated titanium dioxide, where the titanium dioxide is preferably coated with alumina or polysiloxane; from about 0.01 wt % to about 0.1 wt % of a fluorescent brightener, specifically wherein the fluorescent brightener contains two benzoxazolyl groups, preferably 4,4′-bis(2-benzoxazolyl) stilbene or 2,5-bis(5-tert-butyl-2-benzoxazolyl) thiophene; from about 0.05 wt % to about 20 wt % of a flame retardant, specifically a perfluorobutane sulfonic acid salt or a phosphazene flame retardant, preferably having the structure of Formula (II) or Formula (III) as described above; optionally, from about 5 wt % to about 50 wt % of a polycarbonate-polysiloxane copolymer; optionally, from about 0.05 wt % to about 1 wt % of an anti-drip agent; and wherein the polycarbonate composition has a reflectivity (R %) of 96% or greater at 1.0 mm thickness and has V0 performance at 1.0 mm thickness, and specifically a reflectivity (R %) of 96% or greater at 0.3 mm thickness together with V0 performance at 0.8 mm thickness. Optionally in any of the foregoing embodiments, the polycarbonate meets at least one of the following standards: an MFR of 6 g/10 min or higher when measured at 300° C., 1.2 kg according to ASTM D1238; and a pFTP(V0) of at least 0.90 and a flame out time (FOT) of about 40 seconds or less at 0.8 mm thickness. An article can be molded from any of the polycarbonate compositions, specifically a reflector, a film, a lamp shade, or a light tube.

In another embodiment, a reflective polycarbonate composition comprises: from about 70 wt % to about 80 wt % of the high molecular weight polycarbonate polymer; from about 3 wt % to about 10 wt % of the low molecular weight polycarbonate polymer; from about 15 wt % to about 25 wt % of the white colorant, for example titanium dioxide, zinc sulfide, zinc oxide, or barium sulfate, and specifically coated titanium dioxide, where the titanium dioxide is preferably coated with alumina or polysiloxane; from about 0.01 wt % to about 0.1 wt % of the fluorescent brightener wherein the fluorescent brightener contains two benzoxazolyl groups, preferably 4,4′-bis(2-benzoxazolyl) stilbene or 2,5-bis(5-tert-butyl-2-benzoxazolyl) thiophene; from about 0.3 wt % to about 0.6 wt % of the flame retardant specifically a perfluorobutane sulfonic acid salt or a phosphazene flame retardant, preferably having the structure of Formula (II) or Formula (III) as described above; from about 0.05 to about 0.3 wt % of an anti-drip agent, specifically TSAN; from about 0.3 wt % to about 0.5 wt % of a mold release agent; and from about 0.01 to about 0.1 wt % of a phosphite stabilizer wherein the polycarbonate composition has a reflectivity (R %) of 96% or greater at 1.0 mm thickness and has V0 performance at 1.0 mm thickness, and specifically a reflectivity (R %) of 96% or greater at 0.3 mm thickness together with V0 performance at 0.8 mm thickness. Optionally in any of the foregoing embodiments, the polycarbonate meets at least one of the following standards: an MFR of 6 g/10 min or higher when measured at 300° C., 1.2 kg according to ASTM D1238; and a pFTP(V0) of at least 0.90 and a flame out time (FOT) of about 40 seconds or less at 0.8 mm thickness. An article can be molded from any of the polycarbonate compositions, specifically a reflector, a film, a lamp shade, or a light tube.

In still another embodiment, a reflective polycarbonate composition, comprises from about 10 wt % to about 90 wt %, specifically from about 65 wt % to about 75 wt %, of a polycarbonate polymer, of the polycarbonate polymer; from about 5 wt % to about 60 wt %, specifically from about 15 wt % to about 35 wt %, of a white colorant, for example titanium dioxide, zinc sulfide, zinc oxide, or barium sulfate, and specifically coated titanium dioxide, where the titanium dioxide is preferably coated with alumina or polysiloxane; and from about 0.01 wt % to about 0.1 wt %, specifically from about 0.01 wt % to about 0.1 wt %, of a fluorescent brightener, wherein the fluorescent brightener contains two benzoxazolyl groups, preferably 4,4′-bis(2-benzoxazolyl) stilbene or 2,5-bis(5-tert-butyl-2-benzoxazolyl) thiophene; optionally from about 0.1 wt % to about 0.5 wt % of a mold release agent and optionally from about 0.01 to about 0.1 wt % of a phosphite stabilizer, wherein the polycarbonate composition has a reflectivity (R %) of 96% or greater at 1.0 mm thickness and has V2 performance at 0.3 mm thickness, even in the absence of a flame retardant and antidrip agent. An article can be molded from any of the polycarbonate compositions, specifically a reflector, a film, a lamp shade, or a light tube.

The following examples are provided to illustrate the polycarbonate blends of the present disclosure. The examples are merely illustrative and are not intended to limit the disclosure to the materials, conditions, or process parameters set forth therein.

### Examples

Table 1 lists the names and descriptions of the ingredients used in the following Examples.

TABLE 1

| | | | Trade | |
|---|---|---|---|---|
| Ingredient | Description | Mw | name | Source |
| PC1 | Bisphenol-A homopolymer, PCP endcapped | 29,600 | LEXAN | SABIC |
| PC2 | Bisphenol-A homopolymer, PCP endcapped | 21,700 | LEXAN | SABIC |
| EXL | a BPA polycarbonate-polydimethylsiloxane | 30,000 | LEXAN | SABIC |
| | copolymer comprising about 20% by weight of | | | |
| | siloxane, 80% by weight of BPA, PCP (p- | | | |
| | cumylphenol) endcapped, average siloxane chain | | | |
| | length of ~35-55 | | | |
| Rimar | Potassium perfluorobutanesulfonate | | Bayowet C4 | Lanxess |
| TSAN | SAN encapsulated PTFE | | TSAN | SABIC |
| PETS | Pentaerythritol tetrastearate, >90% esterified, mold | | PETS G | Faci |
| | release agent | | | |
| PPZ | Diphenoxyphosphazene | | SPB-100 | Otsuka |
| | | | | Chemical |
| | | | | Co., Ltd. |
| R513 | Fluorescent brightener | | TINOPAL | Ciba |
| | | | OB | |
| OB-1 | Fluorescent brightener | | OB-1 | Eastman |
| R107C | Titanium dioxide (coated) | | KRONOS | Kronos |
| | | | 2233 | |
| Stabilizer | Tris(2,4-di-tert-butylphenyl)phosphite | | Irgafos 168 | Ciba |
| UV | Ultraviolet absorber | | UV 5411 | Cytec |
| | | | | Industrial |
| | | | | Corp. |

To make the testing articles, the polycarbonate was pre-blended with other additives, then the pre-blended polycarbonate powder was extruded using a twin screw extruder (TEM-37BS). Extruded pellets were dried in a dehumidifying dryer for 4 hours at 120° C. 1.0 mm color chips and UL94 testing bars of 0.83 mm, 0.9 mm, and 1.0 mm thickness were molded with single gate tooling. Articles of 0.3 mm and 0.4 mm thickness were molded with film gate tooling. Thermal forming was done on the reflective film after film extrusion.

The L, a, b, and % R values were measured using a Color Eye 7000A.

The melt flow rate (MFR) was measured using ASTM D1238 at 300° C., 1.2 kg load. MFR is reported in grams (g) of polymer melt/10 minutes.

The UV aging test was performs using 340 nm UV light, 0.35 W/m²/nm at 23° C.

The notched Izod impact strength (INI) was measured using ASTM D256. Ductility was measured at 23° C.

Flammability tests were performed following the procedure of Underwriter's Laboratory Bulletin 94 entitled “Tests for Flammability of Plastic Materials, UL94.” According to this procedure, materials may be classified as V-0, V-1, or V-2 on the basis of the test results obtained for samples of a given thickness. It is assumed that a material that meets a given standard at a given thickness can also meet the same standard at greater thicknesses (e.g. a material that obtains V0 performance at 0.8 mm thickness can also obtain V0 performance at 1.0 mm thickness, 1.5 mm, etc.). The samples are made according to the UL94 test procedure. Samples were burned in a vertical orientation after aging for 48 hours at 23° C. At least 10 injection molded bars were burned for each UL test. The criteria for each of the flammability classifications tested are described below.

V0: In a sample placed so that its long axis is 180 degrees to the flame, the average period of flaming and/or smoldering after removing the igniting flame does not exceed five seconds and none of the vertically placed samples produces drips of burning particles that ignite absorbent cotton, and no specimen burns up to the holding clamp after flame or after glow. Five bars flame out time (FOT) is the sum of the flame out time for five bars each lit twice for ten (10) seconds each, for a maximum flame out time of 50 seconds. FOT1 is the average flame out time after the first light. FOT2 is the average flame out time after the second light.

V-1, V-2: In a sample placed so that its long axis is 180 degrees to the flame, the average period of flaming and/or smoldering after removing the igniting flame does not exceed twenty-five seconds and, for a V-1 rating, none of the vertically placed samples produces drips of burning particles that ignite absorbent cotton. The V2 standard is the same as V-1, except that flaming drips that ignite the cotton are permitted. Five bar flame out time (FOT) is the sum of the flame out time for five bars, each lit twice for ten (10) seconds each, for a maximum flame out time of 250 seconds.

The data was also analyzed by calculating the average flame out time, standard deviation of the flame out time and the total number of drips, and by using statistical methods to convert that data to a prediction of the probability of first time pass, or “p(FTP)”, that a particular sample formulation would achieve a “pass” rating in the conventional UL94 V0 or V1 testing of 5 bars. The probability of a first time pass on a first submission (pFTP) may be determined according to the formula:

PFTP=(P_{t1>mbt,n=0}×P_{t2>mbt,n=0}×P_{total<=mtbt}×P_{drip,n=0})

where P_{t1>mbt, n=0} is the probability that no first burn time exceeds a maximum burn time value, P_{t2>mbt, n=0} is the probability that no second burn time exceeds a maximum burn time value, P_{total<=mtbt} is the probability that the sum of the burn times is less than or equal to a maximum total burn time value, and P_{drip, n=0} is the probability that no specimen exhibits dripping during the flame test. First and second burn time refer to burn times after a first and second application of the flame, respectively.

The probability that no first burn time exceeds a maximum burn time value, P_{t1>mbt, n=0}, may be determined from the formula: P_{t1>mbt, n=0}=(1−P_{t1>mbt})⁵ where P_{t1>mbt} is the area under the log normal distribution curve for t1>mbt, and where the exponent “5” relates to the number of bars tested. The probability that no second burn time exceeds a maximum burn time value may be determined from the formula: P_{t2>mbt, n=0}=(1−P_{t2>mbt}) where P_{t2>mbt} is the area under the normal distribution curve for t2>mbt. As above, the mean and standard deviation of the burn time data set are used to calculate the normal distribution curve. For the UL-94 V-0 rating, the maximum burn time is 10 seconds. For a V-1 or V-2 rating the maximum burn time is 30 seconds. The probability P_{drip, n=0} that no specimen exhibits dripping during the flame test is an attribute function, estimated by: (1−P_{drip})⁵ where P_{drip}=(the number of bars that drip/the number of bars tested).

The probability P_{total<=mtbt} that the sum of the burn times is less than or equal to a maximum total burn time value may be determined from a normal distribution curve of simulated 5-bar total burn times. The distribution may be generated from a Monte Carlo simulation of 1000 sets of five bars using the distribution for the burn time data determined above. Techniques for Monte Carlo simulation are well known in the art. A normal distribution curve for 5-bar total burn times may be generated using the mean and standard deviation of the simulated 1000 sets. Therefore, P_{total<=mtbt} may be determined from the area under a log normal distribution curve of a set of 1000 Monte Carlo simulated 5-bar total burn time for total<=maximum total burn time. For the UL-94 V-0 rating, the maximum total burn time is 50 seconds. For a V-1 or V-2 rating, the maximum total burn time is 250 seconds.

Preferably, p(FTP) is as close to 1 as possible, for example, greater than or equal to about 0.80, or greater than or equal to about 0.90, or greater than or equal to about 0.95, for maximum flame-retardant performance in UL testing. These standards are more stringent than merely specifying compliance with the referenced V-0 or V-1 test.

### Example

### Reflectivity vs. Thickness

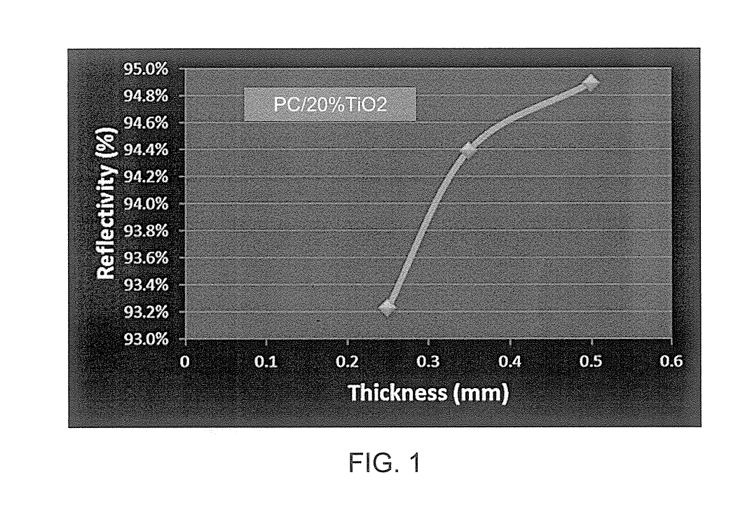

A composition of 80% PC2 and 20% R107C was prepared, and articles were made of 0.25 mm, 0.35 mm, and 0.5 mm thickness. The results are shown in FIG. 1. Generally, the reflectivity decreases for a given composition as the thickness decreases.

### Examples E1-E3

The effect of the colorant loading on the reflectivity was tested. Examples E1-E3 are shown below in Table 2.

TABLE 2

| Ingredient | Unit | E1 | E2 | E3 |
|---|---|---|---|---|
| Stabilizer | wt % | 0.06 | 0.06 | 0.06 |
| PETS | wt % | 0.1 | 0.1 | 0.1 |
| PC2 | wt % | 80 | 70 | 60 |
| R107C | wt % | 20 | 30 | 40 |
| MFR | g/10 | 6.49 | 8.52 | 6.84 |
| | min | | | |
| % Ash | % | 18.14 | 28.255 | 38.445 |
| Tensile Modulus | MPa | 2687.6 | 2930.2 | 3330.8 |
| Ductility (23° C.) | % | 100 | 100 | 0 |
| INI | MPa | 700 | 528 | 204 |
| Flexural Modulus | MPa | 2550 | 2850 | 3270 |
| L | — | 98.2 | 98.4 | 98.5 |
| a | — | −0.5 | −0.5 | −0.6 |
| b | — | 1.6 | 1.6 | 1.6 |
| R % @ 1.0 mm | % | 95.4 | 96.02 | 96.28 |
| R % @ 0.3 mm | % | 94.10 | 95.40 | 95.50 |

As seen here, R % increased as the amount of TiO₂ increased. When 30% TiO₂ was used, R % @ 1 mm and 0.3 mm are higher than 96% and 95%, respectively.

### Examples E4-E8

To improve the R %, a fluorescent brightener was added. Both R513 and OB-1 were tried. Examples E4-E8 are shown below in Table 3.

TABLE 3

| Ingredient | Unit | E4 | E5 | E6 | E7 | E8 |
|---|---|---|---|---|---|---|
| Stabilizer | wt % | 0.06 | 0.06 | 0.06 | 0.06 | 0.06 |
| UV | wt % | 0.27 | 0.27 | 0.27 | 0.27 | 0.27 |
| PETS | wt % | 0.35 | 0.35 | 0.35 | 0.35 | 0.35 |
| PC1 | wt % | 30 | 30 | 30 | 30 | 30 |
| PC2 | wt % | 50 | 50 | 50 | 50 | 50 |
| R107C | wt % | 20 | 20 | 20 | 20 | 20 |
| R513 | wt % | | 0.02 | 0.06 | | |
| OB-1 | wt % | | | | 0.02 | 0.06 |
| MFR | g/10 | 16.2 | 17.1 | 17.3 | 16.6 | 16 |
| | min | | | | | |
| % Ash | % | 18.825 | 19.04 | 19.14 | 19.095 | — |
| L @ 1.0 mm | — | 98.3 | 98.6 | 98.6 | 98.6 | 98.7 |
| a @ 1.0 mm | — | −0.6 | −0.5 | −0.4 | −0.3 | 0 |
| b @ 1.0 mm | — | 1.6 | 0.9 | −0.1 | 0.5 | −1 |
| R % @ 1.0 mm | % | 95.668 | 96.414 | 96.324 | 96.612 | 96.842 |

Both fluorescent brighteners increased the R %. OB-1 was more effective in increasing the R % than R513. As seen here, R % increased as the amount of TiO₂ increased. In addition, the higher R % could be obtained even when using less TiO₂ (compared to E3). An R % of 96.842% was obtained with E8.

### Examples E9-E13

The amount of TiO₂ and the amount of OB-1 were varied. Examples E9-E13 are shown below in Table 4.

TABLE 4

| Ingredient | Unit | E9 | E10 | E11 | E12 | E13 |
|---|---|---|---|---|---|---|
| Stabilizer | wt % | 0.06 | 0.06 | 0.06 | 0.06 | 0.06 |
| PETS | wt % | 0.1 | 0.1 | 0.1 | 0.1 | 0.1 |
| PC2 | wt % | 75 | 75 | 70 | 70 | 70 |
| OB-1 | wt % | | 0.02 | 0.01 | 0.02 | 0.04 |
| R107C | wt % | 25 | 25 | 30 | 30 | 30 |
| MFR | g/10 | 9.02 | 8.66 | 6.99 | 7.27 | 6.63 |
| | min | | | | | |
| % Ash | % | 24.505 | 24.7 | 29.75 | 29.515 | 29.515 |
| L @ 1.0 mm | — | 98.4 | 98.6 | 98.6 | 98.7 | 98.8 |
| a @ 1.0 mm | — | −0.6 | −0.4 | −0.5 | −0.4 | −0.3 |
| b @ 1.0 mm | — | 1.6 | 0.6 | 1.2 | 0.8 | 0 |
| R % @ 1.0 mm | % | 95.89 | 96.48 | 96.41 | 96.62 | 96.97 |
| R % @ 0.3 mm | % | 95.22 | 95.60 | 95.65 | 95.75 | 96.06 |

As seen here, to obtain an R % greater than 96% at 0.3 mm thickness, 30 parts TiO₂ was needed. Again, R % increased as the amount of OB-1 increased.

### Example

### UV Aging

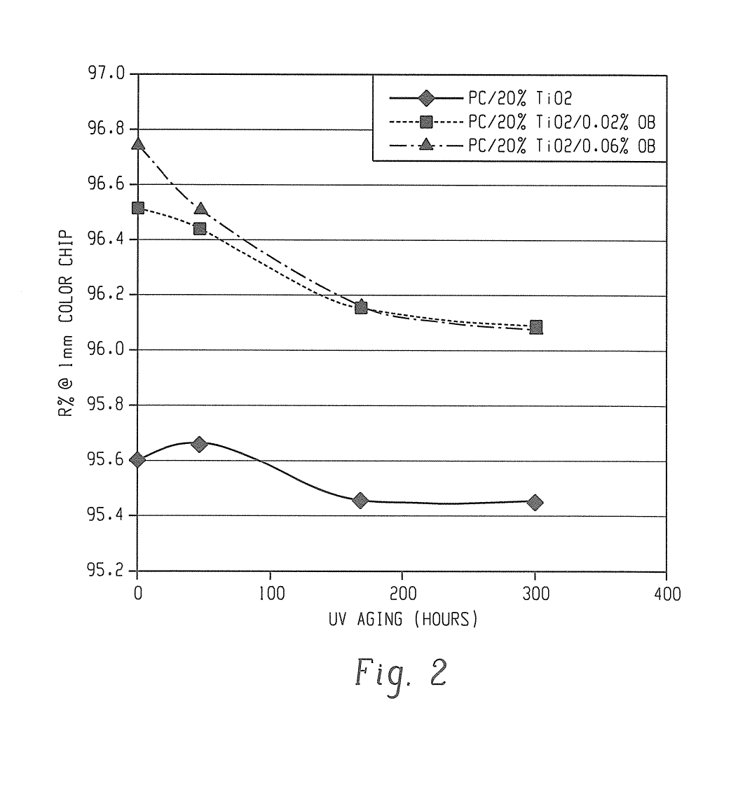

To test the UV resistance of this material, UV testing was done for 300 hrs on three compositions have 80 parts PC2, 20 parts TiO₂, and varying in the amount of OB-1 (0, 0.02 parts, or 0.06 parts). The results are shown in FIG. 2. The results show that the R % of the sample containing 0.06% OB-1 was still higher than the sample containing no OB-1 after 300 hours of UV aging. This indicates that OB-1 does not decrease UV resistance in the polycarbonate composition.

### Examples E14-E22

The amount of TiO₂ and the amount of OB-1 were varied to determine their effect on R %. Examples E14-E22 are shown below in Table 5.

TABLE 5

| Ingredient | Unit | E14 | E15 | E16 | E17 | E18 | E19 | E20 | E21 | E22 |
|---|---|---|---|---|---|---|---|---|---|---|
| Stabilizer | wt % | 0.06 | 0.06 | 0.06 | 0.06 | 0.06 | 0.06 | 0.06 | 0.06 | 0.06 |
| PETS | wt % | 0.3 | 0.3 | 0.3 | 0.3 | 0.3 | 0.3 | 0.3 | 0.3 | 0.3 |
| PC2 | wt % | 59.64 | 79.56 | 74.6 | 79.64 | 79.56 | 69.56 | 59.6 | 59.6 | 59.56 |
| OB-1 | wt % | | 0.08 | 0.04 | | 0.08 | 0.08 | 0.04 | 0.04 | 0.08 |
| R107C | wt % | 40 | 20 | 25 | 20 | 20 | 30 | 40 | 40 | 40 |
| MFR | g/10 | 18.7 | 13.2 | 14.1 | 13.6 | 13 | 11.4 | 10.2 | 10.2 | 10.5 |
| | min | | | | | | | | | |
| % Ash | % | 39.75 | 19.50 | 24.68 | 19.61 | 19.61 | 29.35 | 39.36 | 39.36 | 39.44 |
| L @ 1.0 mm | — | 98.6 | 98.9 | 98.8 | 98.5 | 98.9 | 98.9 | 98.7 | 98.7 | 98.8 |
| a @ 1.0 mm | — | −0.5 | 0.3 | −0.1 | −0.6 | 0.3 | 0.2 | −0.2 | −0.2 | 0 |
| b @ 1.0 mm | — | 1.7 | −1.6 | 0.2 | 2 | −1.7 | −1 | 0.5 | 0.5 | −0.4 |
| R % @ 1.0 mm | % | 96.61 | 97.33 | 96.96 | 96.32 | 97.44 | 97.39 | 96.91 | 96.91 | 97.16 |
| R % @ 0.4 mm | % | 96.43 | 97.13 | 96.87 | 96.1 | 97.22 | 97.28 | 96.84 | 96.84 | 96.97 |
| V2 @ 0.3 mm | — | Pass | Pass | Pass | Pass | Pass | Pass | Pass | Pass | Pass |

Again, R % increased as the amount of OB-1 or TiO₂ increased. However, when the TiO₂% was higher than 30%, R % did not continue increasing. Without being bound by theory, it is believed that the TiO₂ covers the surface of the OB-1 and reduces its fluorescence.

### Examples E23-E25

The compositions of Table 5 only obtained V2 performance. To increase the flame retardance, different FR additives were used. Examples E23-E25 are shown in Table 6.

TABLE 6

| Ingredient | | Unit | E23 | E24 | E25 |
|---|---|---|---|---|---|
| Stabilizer | | wt % | 0.06 | 0.06 | 0.06 |
| PETS | | wt % | 0.35 | 0.35 | 0.35 |
| TSAN | | wt % | 0.2 | 0.2 | 0.2 |
| Rimar | | wt % | 0.5 | | |
| PC1 | | wt % | 72.98 | 23.5 | 25 |
| PC2 | | wt % | 5.86 | 43.5 | 45 |
| OB-1 | | wt % | 0.05 | | |
| EXL | | wt % | | 10 | 8 |
| PPZ | | wt % | | 3 | 2 |
| R107C | | wt % | 20 | 20 | 20 |
| MFR | | g/10 | 21.8 | 16.7 | 13.8 |
| | | min | | | |
| % Ash | | % | 19.74 | 20.66 | 20.66 |
| L @ 1.0 mm | | — | 98.9 | 98.2 | 98.2 |
| a @ 1.0 mm | | — | −0.1 | −0.5 | −0.5 |
| b @ 1.0 mm | | — | −0.7 | 2 | 1.9 |
| R % @ 1.0 mm | | % | 97.25 | 95.56 | 95.68 |
| (1 mm, | FOT | sec | 33.5 | 22.35 | 65.3 |
| 23 C., | Drip | — | 0 | 0 | 1 |
| 48 h) | Time out | — | 1 | 0 | 1 |
| | pFTP | — | 0.61 | 0.97 | 0.48 |
| | Rating | — | V0 | V0 | V0 |
| (1 mm, | FOT | sec | 28.8 | 25.55 | 27.6 |
| 70 C., | Drip | — | 0 | 0 | 0 |
| 168 h) | Time out | — | 1 | 0 | 0 |
| | pFTP | — | 0.63 | 0.85 | 0.99 |
| | Rating | — | V0 | V0 | V0 |
| (0.83 mm, | FOT | sec | | | 46.35 |
| 23 C., | Drip | — | | | 0 |
| 48 h) | Time out | — | | | 1 |
| | pFTP | — | | | 0.45 |
| | Rating | — | | | V0 |
| (0.83 mm, | FOT | sec | | | 36.4 |
| 70 C., | Drip | — | | | 0 |
| 168 h) | Time out | — | | | 0 |
| | pFTP | — | | | 0.94 |
| | Rating | — | | | V0 |

Ten injection molded bars were burned for each UL test. For E25, only one bar had both dripping and time out during the 1 mm V0 test. As seen in Table 6, when phosphazene (PPZ) and EXL are used V0 @ 1 mm thickness can be obtained (E24), and their R % @ 1 mm is higher than 95%. When Rimar was used, V0 @ 1 mm thickness with R % @ 1 mm of 97% can be achieved (E23).

### Example

### Film Properties

Foamed PET has been widely used to make reflective films. To compare the processing properties of the polycarbonate compositions of the present disclosure with that of foamed PET, thermoforming of a film was performed. The polycarbonate composition contained 74.45 wt % polycarbonate, 25 wt % TiO2, 0.5 wt % Rimar, and 0.05 wt % OB-1. The thickness of the film was 0.25 mm.

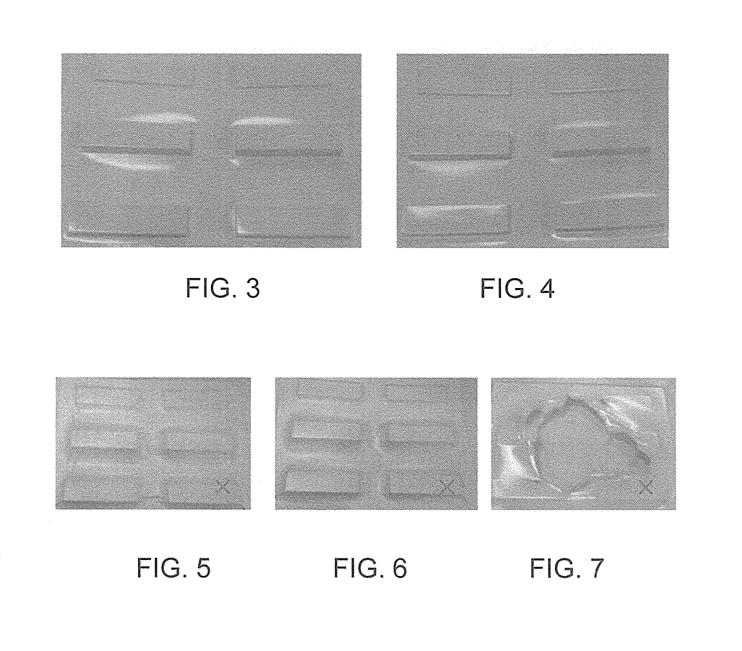

FIG. 3 shows the polycarbonate composition when the thermoforming temperature was 178° C. FIG. 4 shows the polycarbonate composition when the thermoforming temperature was 197° C.

FIG. 5 shows foamed PET when the thermoforming temperature was 160° C. FIG. 5 shows foamed PET when the thermoforming temperature was 174° C. FIG. 7 shows foamed PET when the thermoforming temperature was 187° C.

As seen in FIGS. 5-7, it was difficult to get a good final product using foamed PET. When the forming temperature was low, the product shrank. When the forming temperature was increased, the film broke. With the polycarbonate composition, a good film was obtained at low and high temperatures. Furthermore, when the foamed PET was used for reflective film, if the film was too soft, it was difficult to maintain the smoothness of the film when assembling the film on a backboard. The X's indicate unacceptable specimens.

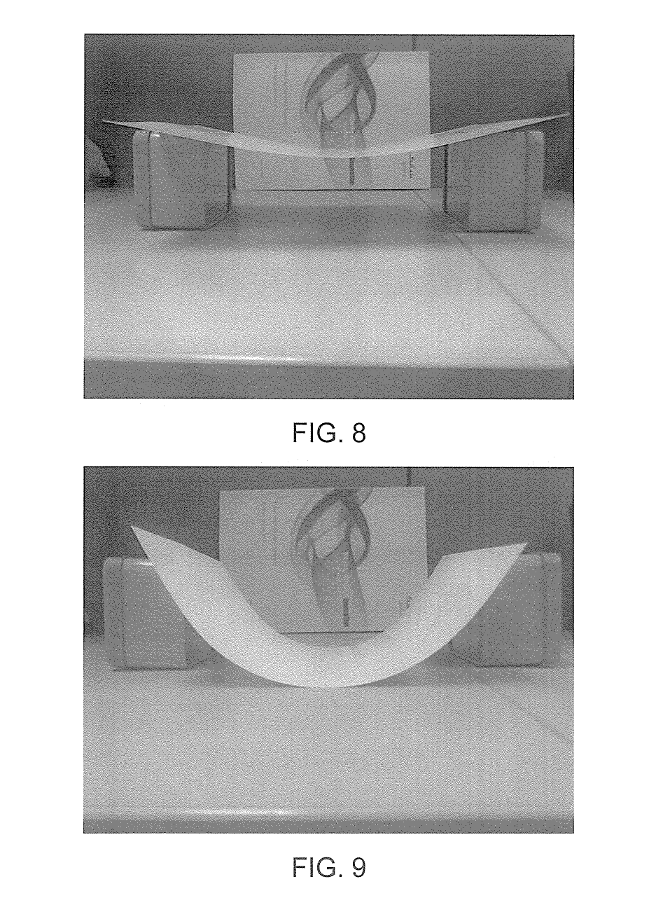

FIG. 8 is a picture showing a 0.25 mm thick film of the polycarbonate composition. FIG. 9 is a picture showing a 0.25 mm thick film of foamed PET. The polycarbonate composition was stronger than foamed PET, and maintained its shape better, indicating better mechanical performance.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A reflective polycarbonate composition, comprising:
from about 10 wt % to about 90 wt % of a polycarbonate polymer;
from about 5 wt % to about 60 wt % of a white colorant;
from about 0.01 wt % to about 0.1 wt % of a fluorescent brightener; and
from about 0.05 wt % to about 20 wt % of a flame retardant;
wherein the polycarbonate composition has a reflectivity of 96% or greater at 1.0 mm thickness and has V0 performance at 1.0 mm thickness.

2. The polycarbonate composition of claim 1, wherein the white colorant is titanium dioxide, zinc sulfide, zinc oxide, or barium sulfate.

3. The polycarbonate composition of claim 1, wherein the white colorant is coated titanium dioxide, where the titanium dioxide is coated with alumina or polysiloxane.

4. The polycarbonate composition of claim 1, containing from about 5 wt % to about 30 wt % of the white colorant.

5. The polycarbonate composition of claim 1, wherein the fluorescent brightener contains two benzoxazolyl groups.

6. The polycarbonate composition of claim 1, wherein the fluorescent brightener is 4,4′-bis(2-benzoxazolyl) stilbene or 2,5-bis(5-tert-butyl-2-benzoxazolyl) thiophene.

7. The polycarbonate composition of claim 1, wherein the flame retardant is a perfluorobutane sulfonic acid salt.

8. The polycarbonate composition of claim 1, wherein the flame retardant is a phosphazene flame retardant.

9. The polycarbonate composition of claim 8, wherein the phosphazene flame retardant has the structure of Formula (II) or Formula (III): 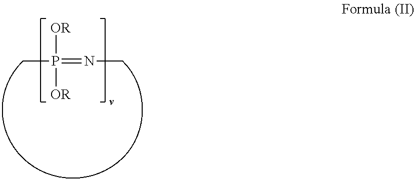
wherein R is alkyl or aryl; and wherein v is an integer from 3 to 25; 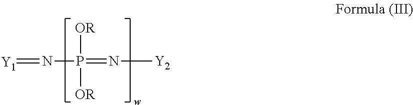
wherein R is alkyl or aryl; w is an integer from 3 to about 1,000; Y₁ is —P(OR)₃ or —P(═O)(OR) and Y₂ is —P(OR)₄ or —P(═O)(OR)₂.

10. The polycarbonate composition of claim 1, wherein the composition further comprises from about 5 wt % to about 50 wt % of a polycarbonate-polysiloxane copolymer.

11. The polycarbonate composition of claim 1, wherein the polycarbonate composition has a reflectivity of 96% or greater at 0.3 mm thickness and has V0 performance at 0.8 mm thickness.

12. The polycarbonate composition of claim 1, wherein the polycarbonate polymer has a weight average molecular weight of from about 15,000 to about 30,000.

13. The polycarbonate composition of claim 1, wherein the composition has a melt flow rate of 6 g/10 min or higher when measured at 300° C., 1.2 kg according to ASTM D1238.

14. The polycarbonate composition of claim 1, wherein the composition has a pFTP(V0) of at least 0.90 and a flame out time of about 40 seconds or less at 0.8 mm thickness.

15. The polycarbonate composition of claim 1, further comprising from about 0.05 wt % to about 1 wt % of an anti-drip agent.

16. The polycarbonate composition of claim 1, wherein the polycarbonate polymer comprises a high molecular weight polycarbonate polymer having an Mw above 25,000 and a low molecular weight polycarbonate polymer having an Mw below 25,000.

17. The polycarbonate composition of claim 16, wherein the weight ratio of the high molecular weight polycarbonate polymer to the low molecular weight polycarbonate polymer is from about 20:80 to about 80:20.

18. The polycarbonate composition of claim 1, wherein the polycarbonate composition comprises:
from about 70 wt % to about 80 wt % of the high molecular weight polycarbonate polymer;
from about 3 wt % to about 10 wt % of the low molecular weight polycarbonate polymer;
from about 15 wt % to about 25 wt % of the white colorant;
from about 0.01 wt % to about 0.1 wt % of the fluorescent brightener;
from about 0.3 wt % to about 0.6 wt % of the flame retardant;
from about 0.05 to about 0.3 wt % of an anti-drip agent;
from about 0.3 wt % to about 0.5 wt % of a mold release agent; and
from about 0.01 to about 0.1 wt % of a phosphite stabilizer.

19. A reflective polycarbonate composition, comprising:
from about 10 wt % to about 90 wt % of a polycarbonate polymer;
from about 5 wt % to about 60 wt % of a white colorant; and
from about 0.01 wt % to about 0.1 wt % of a fluorescent brightener;
wherein the polycarbonate composition has a reflectivity of 96% or greater at 1.0 mm thickness and has V2 performance at 0.3 mm thickness.

20. The polycarbonate composition of claim 19, wherein the fluorescent brightener contains two benzoxazolyl groups.

21. The polycarbonate composition of claim 19, wherein the fluorescent brightener is 4,4′-bis(2-benzoxazolyl) stilbene or 2,5-bis(5-tert-butyl-2-benzoxazolyl) thiophene.

22. The polycarbonate composition of claim 1, wherein the polycarbonate composition comprises:
from about 65 wt % to about 75 wt % of the polycarbonate polymer;
from about 15 wt % to about 35 wt % of the white colorant;
from about 0.01 wt % to about 0.1 wt % of the fluorescent brightener;
from about 0.1 wt % to about 0.5 wt % of a mold release agent; and
from about 0.01 to about 0.1 wt % of a phosphite stabilizer.

23. An article molded from the polycarbonate composition of claim 1.

24. The article of claim 23, wherein the article is a reflector, a film, a lamp shade, or a light tube.
